(19) United States
(12) Patent Application Publication
(10) Pub. No.: US 2010/0011973 A1
(43) Pub. Date: Jan. 21, 2010

(54) Plantain slicer

(76) Inventor: Marianela Kovacs, Wayne, NJ (US)

Correspondence Address: Marianela Kovacs, 183 Beechwood Drive, Wayne, NJ, 07470, US

(21) Appl. No.: 12/460,401

(22) Filed: Jul. 17, 2009

Related U.S. Application Data
(60) Provisional application No. 61/135,209, filed on Jul. 18, 2008.

(51) Int. Cl. A47J 43/04; B26D 1/02

(52) U.S. Cl. 99/537; 83/858

(57) ABSTRACT

A utensil or tool specifically adapted for manually slicing ripened plantains, overcoming the previous method of a single blade knife, producing one slice at a time. The plantain slicer includes a frame which encompasses an area generally conforming to the shape and size of a typical plantain as well as other similar shaped vegetables and fruits. The frame has two opposing arched longitudinal sides which are interconnected with a multitude of spaced, substantially parallel arranged ribs, set at a diagonal. The ribs are sufficiently thin to cut diagonally through a pealed ripened plantain, vegetable and fruit. The user will have the ability to grasp the utensil by the handles which are located at each end of the frame and slice through the plantain by pushing down. The end result is uniform diagonal slices in one single action, allowing for even cooking. Openings in the handles permit the hanging of the utensil for storage.

### BACKGROUND OF INVENTION

Ripped Plantain, also referred to as platano maduro, (by Latin Americans), is a cooking banana and a staple food source of Latin American, Caribbean countries, as well as parts southern Asia, India, South Pacific Islands and Africa Known as “cooking bananas,” plantains have been cultivated for thousands of years. The fruit thrives in tropical climate. While a member of the banana family, the plantain is not eaten raw and has more starch than the banana.

Methods for the culinary preparation of plantains include frying, boiling, roasting, stewing, and mashing. The plantain is typically fried in both its ripened and unripe stages. In the most common method the peel is removed and the fruit is sliced and cooked in heated cooking oil until golden brown. Recipe for the preparing of sliced plantains can be found in books in many cultures around world. The plantain can be served as an appetizer, side dish with a main course or as a dessert.

The standard method of cutting the plantain into slices has been typically accomplished with a single blade knife. This process is slow and makes it difficult to produce even uniform slices, especially for the preparation of the ripened plantain. When manually cut slices are placed in the heated cooking oil, the uneven each sections of a slice will cook at different speeds, causing areas to be burned before the entire slice is cooked. This produces parts undesirable for eating as well as an unattractive presentation of the food.

Plantains are a food eaten daily in many households; therefore a need for an improved method of slicing the ripened plantain exists in the manual preparation of this food. As well as a need for an improved devise which prevents the uneven thickness of plantain slices for better cooking.

### SUMMARY OF THE INVENTION

The objective of the inventor is to provide a slicing utensil that simplifies the previous method and system used for the slicing of ripened plantains, or similar elongated vegetables and fruits. In doing, so addressing the need for an improved process which produces multiple slices at the desired angle needed, at even thicknesses, for better preparation of ripened plantains. The invention enables it's user to easily work the devise without the dangers of being cut by a sharp metal knife blade. The plantain slicer frame encompasses an area slightly larger and conforming to the shape and size of a typical plantain as well as other similar shaped vegetables and fruits. The two opposing arched longitudinal sides which are interconnected with a multitude of spaced, substantially parallel arranged ribs, set at a diagonal are sufficiently thin enough to cut diagonally through a pealed ripened plantain. The utensil handles which are located at each end of the frame allow for easy grasping. The utensil is used by holding it on top of the ripened plantain while it is on a hard flat surface, (such as cutting board, counter top or table), and then by pushing the slicer down on the ripened plantain until the utensil makes contact with the flat surface the plantain rests upon.

In conclusion, the final result is a uniformed diagonal multiple slices in one single action, allowing for even cooking and expedited preparation time. A slicing tool made of Polypropylene which meets FDA standards for utensils used for the preparation of food and can be easily cleaned by hand or in a dishwasher.

### BRIEF DESCRIPTION OF THE DRAWINGS

FIG. 1 illustrates a perspective view of the plantain slicer embodiment of the present invention, also showing a pealed plantain, about to be sliced;

FIG. 2 illustrates a top view of the plantain slicer embodiment of the present invention;

FIG. 3 illustrates a side view of the plantain slicer embodiment of the present invention;

FIG. 4 illustrates a cross-sectional view, taken on lines 8, 8 of FIG. 2;

FIG. 5 illustrates a cross-sectional view, taken on lines 7, 7 of FIG. 2, and

FIG. 6 illustrates a secondary perspective view of the plantain slicer embodiment of the present invention, the view showing a plurality of diagonal plantain slices, as a result of using the slicer.

### DETAILED DESCRIPTION OF THE INVENTION

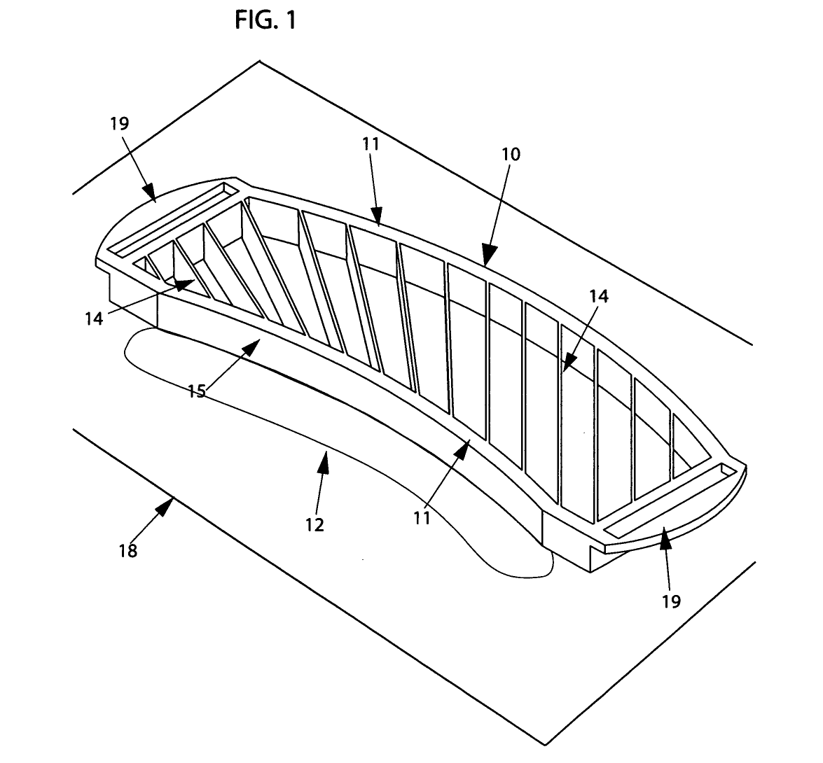

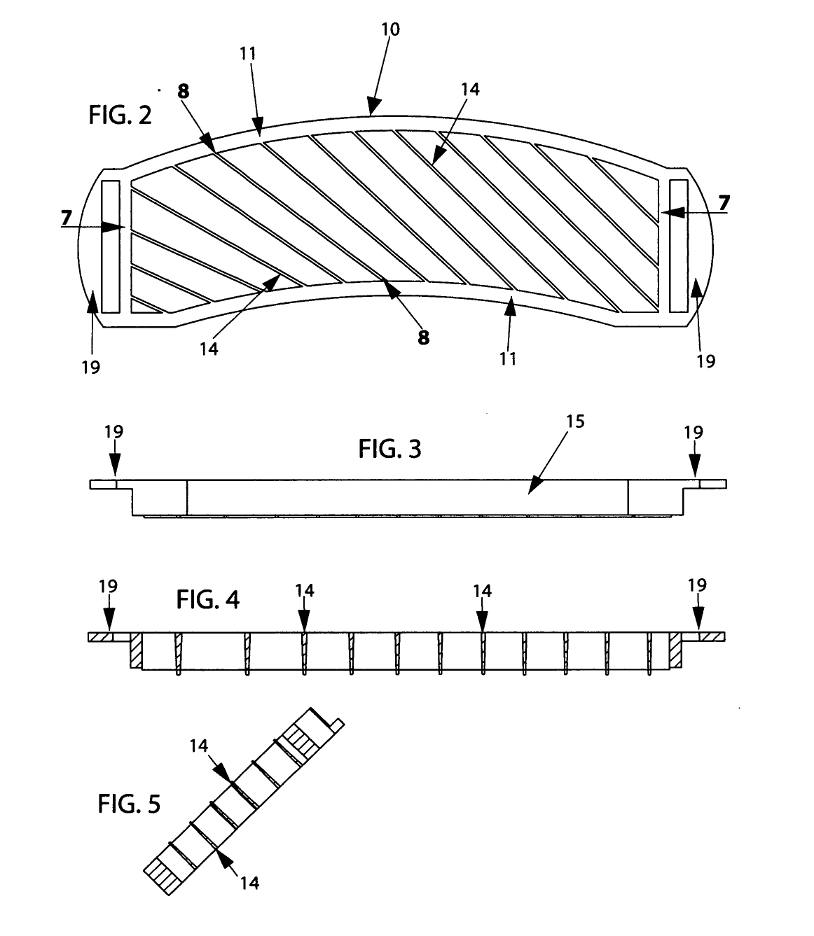

The present invention will now be described in more detail, with reference to the accompanying drawings in which the preferred embodiments of the invention are illustrated. Terms used herein are commonly understood by one of ordinary skill in the art to which this invention pertains. It should be noted that various modifications can be accomplished within the parameters of the present invention. Other features and advantages of the invention will be apparent from the following detailed description, and from the claims.

Where used in the various figures of the drawing, the same numerals designate the same or similar parts. FIG. 1 illustrates an overview of the basic embodiment 10, of the plantain slicer invention. The plantain slicer invention is preferably made from plastic materials by a relatively simple and inexpensive manufacturing process, well adapted for mass production, such as plastic molding. The described preferred embodiment is made from polypropylene. Other plastic materials or metals, such as aluminum or stainless steel, are also suitable. Prior research by the inventor has resulted in the knowledge that molded plastic being the most cost effective of these materials.

As illustrated in FIG. 1, of the present invention is comprises a single, unitary piece, which is described in detail below. The preferred embodiment 10 comprises a substantially flat frame 11, which circumscribes an area sufficiently large enough to contain a typical plantain 12, or similar vegetable or fruit, (not shown), when laid to rest on its side. The foregoing is shown on the exploded perspective view of FIG. 1, as it is revealed by the drawing figures which illustrate the preferred embodiment 10 of the invention. The frame 11 of the plantain slicer conforms to the curvature of a typical or ordinary plantain 12. Thus, the plantain slicer 10 is elongated and the frame 11 is curvilinear so that the slicer fits on top of a typical plantain 12, as is specifically illustrated in FIG. 1.

Diagonally parallel disposed blades or ribs 14 interconnect two elongated sides 15 of the frame 11. The positioning of the blades or ribs 14 is such that when the plantain slicer 10 is laid to rest on a horizontal flat support surface, (not shown), the blades or ribs 14 are vertical. In accordance with the invention, the blades or ribs 14 must be sufficiently thin enabling the cutting tool to slice through a plantain 12, without having a specially sharpened single edged blade, such as a knife. Subsequently, because the blades 14 are preferably made from plastic, they cannot be so thin or narrow that their structural integrity would be compromised, or so thin that they could not be manufactured by suitable manufacturing processes, such as plastic molding. For these reasons, the blades or ribs 14 of the preferred embodiment are approximately 0.048 inches wide at the tops and taper down to 0.025 inches in width at the base. It should be understood that their width can vary as long as the foregoing requirements are met, without compromising their structural integrity.

Spacing between the blades or ribs 14 substantially determines the thickness of the plantain slices 12 which are cut with the utensil of the present invention. Whereas the spacing of the blades 14 can vary depending on preference for thicker or thinner plantain slices, in the herein described preferred embodiment 10 the blades 14 are approximately 0.5 inches apart, with a variance on certain blades, at the frames curve, to maintain the desired diagonal.

Illustrated in the FIG. 4 cross-sectional view the blades 14 of the preferred embodiment are shown to extend slightly, approximately 0.035 inches, below the frame 11, so that when the plantain slicer 10 is placed on a flat support surface, such as a cutting board or table, (not shown), the plantain slicer 10 rests on the bottom of the blades 14 and not on the frame 11. The slicer 10 of the preferred embodiment is approximately 10.843 inches long, and at its widest point it is approximately 3.665 inches wide. Although the number of blades or ribs 14 is not critical, it is noted that the herein described preferred embodiment 10 has fourteen (14) spaced blades or ribs 14.

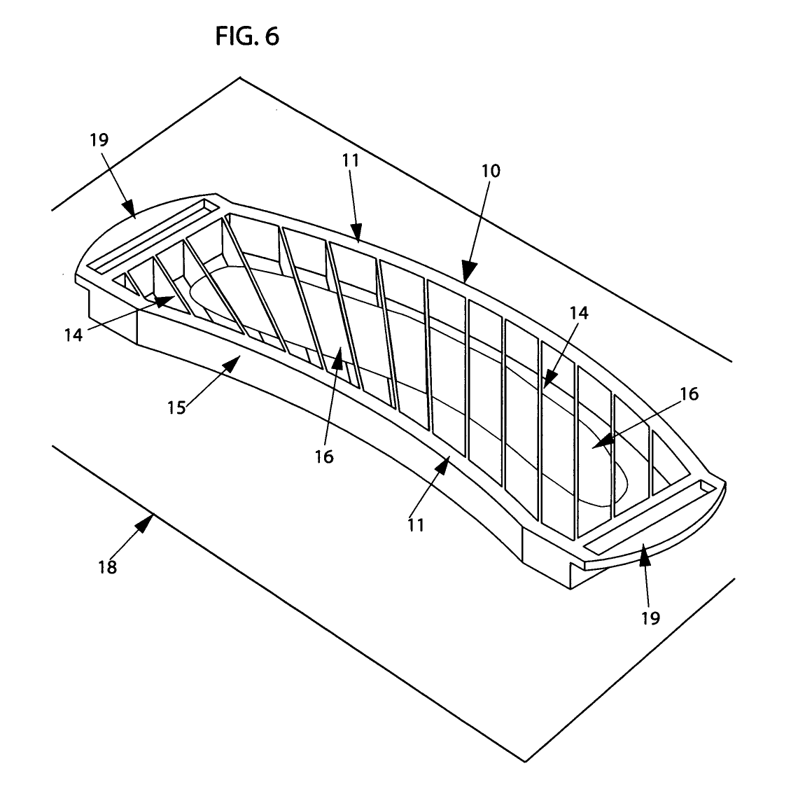

In the FIGS. 1, 3, 4 and 6 illustrations the ends or handles 19 of the plantain slicer 10 of the preferred embodiment are shown to be even with the top of the frame, as an extension of the plane generally defined by the frame 11. The straight and extended ends or handles 19 make it easier for a user, (not shown), to hold and manipulate the slicer 10, especially after the slicer 10 has been used to cut a plantain 12, as is shown on FIG. 6 of the appended illustrations.

The embodiment of the present invention is best utilized by first placing the plantain 12 on a support surface 18, and thereafter holding the slicer 10 above and substantially parallel with the plantain 12 and pushing the slicer 10 down until the ribs or blades 14 make contact with the support surface 18. The foregoing is shown schematically on FIG. 1.

The freshly cut plantain slices 12 have a tendency to adhere to the ribs or blades 14 of the plantain slicer 10. The release of any subsequently stuck slices from the utensil is accomplished by holding the utensil handles 19 firmly with the thumbs and forefingers of the hand, (not shown), above the flat work surface, then tapping the bottom side of the closed hands, (not shown), firmly on said flat working surface. This action will subsequently cause the release of the remainder of the plantain slices 16 from the plantain slicer 10 with little effort. The use of hands or other instrument, (not shown), can also be used to accomplish this task. The accomplished task results in the plantain 16, or comparable vegetable or fruit, (not shown), being uniformly sliced diagonally, in one single action. Openings in each of the utensil handles 19 of the slicer 10, provide the user, (not shown), the ability to hang the slicer 10 for storage on a peg (not shown), or the like.

Accordingly, in the illustrations and specification described herein, the typical preferred embodiments of the invention, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as recited in the appended claims.

The claim is:

1. A utensil or tool for manually slicing a ripened plantain, as well as other soft meat elongated vegetables and fruit, into individual diagonal slices, using this cutting device. Addressing the slower less efficient method of slicing a plantain with single blade knife, producing one slice at a time. The plantain slicer includes a frame which encompasses an area generally conforming to the shape and size of a typical plantain and other similar shaped vegetables and fruits. The frame has two opposing arched longitudinal sides which are interconnected with a multitude of spaced, substantially parallel arranged ribs, set at a diagonal. The ribs are sufficiently thin to cut diagonally through a pealed ripened plantain, or other vegetables and fruits. The user will have the ability to grasp the utensil by the handles which are located at each end of the frame and slice through the ripe plantain by pushing down. The end result being uniformed diagonal slices of ripened plantain in one single action.

2. The plantain utensil of claim 1 produces slices of consistently even thickness enabling a uniformly prepared or cooked food.

3. The plantain utensil of claim 1 provides a plantain slicer which is safe in nature and which also provides a similar but more efficient method for the preparation of the ripened plantain.

4. The plantain slicing utensil of claim 1 consisting essentially of Polypropylene.

5. The plantain slicing utensil of claim 1 wherein each diagonal parallel arranged rib is approximately 0.048 inches at the top, tapering down to 0.025 at the bottom.

6. The plantain slicing utensil of claim 1 wherein each diagonal parallel arranged rib are disposed at an approximate distance of 0.5 from one another.
